(19) United States
(12) Patent Application Publication
(10) Pub. No.: US 2018/0014065 A1
(43) Pub. Date: Jan. 11, 2018

(54) Video File Processing Method and Device

(71) Applicant: TENCENT TECHNOLOGY (SHENZHEN) COMPANY LIMITED, Shenzhen (CN)

(72) Inventor: Long Cheng, Shenzhen (CN)

(21) Appl. No.: 15/711,267

(22) Filed: Sep. 21, 2017

Related U.S. Application Data
(63) Continuation of application No. PCT/CN2016/078418, filed on Apr. 5, 2016.

(30) Foreign Application Priority Data
Apr. 9, 2015 (CN) 201510165538.2

(51) Int. Cl. H04N 21/4402; H04N 21/433

(52) U.S. Cl. CPC H04N 21/4402; H04N 21/433

(57) ABSTRACT

Embodiments of the present disclosure may provide a video file processing method, including: receiving a splitting instruction of a video file; determining splitting nodes corresponding to the splitting instruction; splitting the video file to multiple sub-video files using the splitting nodes; and storing the multiple sub-video files. Embodiments of the present disclosure may further provide a video file processing device. With the embodiments of the present disclosure, the video file may be segmentally displayed, which may optimize management of the video file.

This application is a continuation of International Application No. PCT/CN2016/078418, filed on Apr. 5, 2016, which further claims the benefit of priority from a Chinese Patent Application, No. 201510165538.2, entitled “Video file processing method and device” and filed on Apr. 9, 2015, the entire content of which is hereby incorporated by reference.

### FIELD OF THE TECHNOLOGY

The present disclosure relates to a computer field, and more particularly, to video file processing methods and devices.

### BACKGROUND

With the development of video technologies and Internet technologies, more and more users may upload recorded video files to the Internet, so that other users may view and watch the video using the video files.

### SUMMARY

Embodiments of the present disclosure may provide video file processing methods and devices, to improve video playing efficiency.

An embodiment of the present disclosure may provide a video file processing method, including:

receiving a splitting instruction of a video file;

determining splitting nodes corresponding to the splitting instruction;

splitting the video file to multiple sub-video files using the splitting nodes; and

storing the multiple sub-video files.

An embodiment of the present disclosure may provide a video file processing device, including: a processor and a storage;

wherein the processor executes a video file processing program in the storage to:

receive a splitting instruction of a video file;

determine splitting nodes corresponding to the splitting instruction;

split the video file to multiple sub-video files using the splitting nodes; and

store the multiple sub-video files.

An embodiment of the present disclosure may provide a video file processing method, including:

receiving a splitting instruction of a video file;

determining splitting nodes corresponding to the splitting instruction;

generating playing links of multiple sub-video files of the video file using the splitting nodes; and

displaying the playing links of the multiple sub-video files.

An embodiment of the present disclosure may provide a video file processing device, including: a processor and a storage;

wherein the processor executes a video file processing program in the storage to:

receive a splitting instruction of a video file;

determine splitting nodes corresponding to the splitting instruction;

generate playing links of multiple sub-video files of the video file using the splitting nodes; and

display the playing links of the multiple sub-video files.

In embodiments of the present disclosure, the splitting instruction of the video file may be received, splitting nodes may be determined according to the splitting instruction, the video file may be split to multiple sub-video files, so that the user may select one sub-video file to play. With the technical scheme of the present disclosure, the video file may be segmentally played and the management of the video file may be optimized.

### BRIEF DESCRIPTION OF THE DRAWINGS

FIG. 1 is a schematic diagram illustrating structure of a video file processing device in accordance various embodiments of the present disclosure;

FIG. 2 is a flow chart illustrating a video file processing method in accordance with various embodiments of the present disclosure;

FIG. 3 is a flow chart illustrating a video file splitting method in accordance with various embodiments of the present disclosure;

FIG. 4 is a flow chart illustrating a video file splitting method in accordance with various embodiments of the present disclosure;

FIG. 5 is a flow chart illustrating a video file splitting method in accordance with various embodiments of the present disclosure;

FIG. 6 is a flow chart illustrating a video file processing method in accordance with various embodiments of the present disclosure;

FIG. 7 is a schematic diagram illustrating structure of a video file processing device in accordance various embodiments of the present disclosure;

FIG. 8 is a schematic diagram illustrating structure of a processing module in FIG. 7;

FIG. 9 is a schematic diagram illustrating structure of a video file processing device in accordance various embodiments of the present disclosure;

FIG. 10 is a flow chart illustrating a video file processing method in accordance with various embodiments of the present disclosure;

FIG. 11 is a schematic diagram illustrating structure of a video file processing device in accordance various embodiments of the present disclosure.

### DETAILED DESCRIPTION OF THE DRAWINGS

It should be understood that embodiments described in the present disclosure are only used to explain the present disclosure, but not used to limit the present disclosure.

When a user plays a video file using a player, for instance in a teaching field, when the user plays an instructional video file downloaded from the Internet, since the instructional video file may include many pieces of time and the pieces of time may be cluttered, the user may experience several interruptions before finishing the watching of the video. Embodiments of the present disclosure may provide a video file processing scheme. With this scheme, the video file may be segmentally displayed, which may optimize management of the video file.

In embodiments of the present disclosure, a splitting instruction of a video file may be received, splitting nodes and the video file corresponding to the splitting instruction may be obtained, the video file may be split to sub-video files corresponding to the splitting nodes, and the sub-video files obtained by the splitting operation may be stored. Via receiving the splitting instruction of the video file, the video file may be split to multiple sub-video files. Therefore the video file may be segmentally managed, which may optimize the management of the video file. Further, the user may select one of the sub-video files to finish the learning process. It may be avoided that with the existing instructional video file, the instructional video file cannot be split in a predictable way, resulting in poor instructional video playing efficiency and poor learning efficiency. Therefore, through splitting the instructional video file in a predictable way, playing efficiency of the instructional video may be improved and the learning efficiency may be improved.

Embodiments of the present disclosure may provide a video file processing device. The video file processing device may split a video file to multiple video sub-files based on a splitting instruction of the video file, which may be convenient for the user to finish the learning by planning. The problem of poor video playing efficiency and poor learning efficiency since the existing video file cannot be split according to user's expectations may be avoided. With this scheme, the video file may be split according to the user's expectations, which may improve the video playing efficiency and learning efficiency.

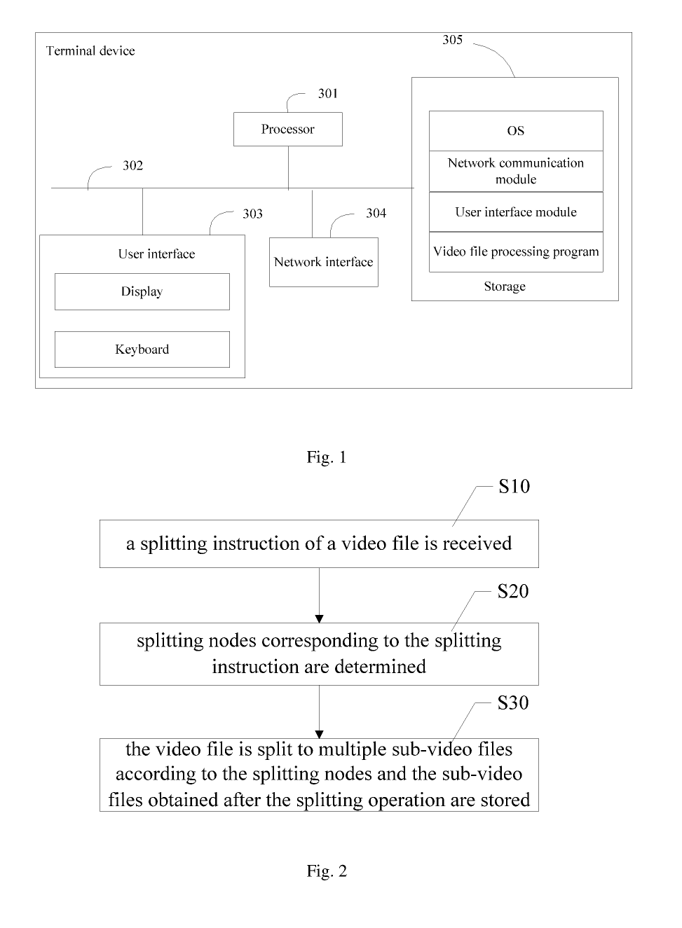

The video file processing device in embodiments of the present disclosure may be set on an electronic terminal device, such as a PC, a smart phone or a tablet PC, which may load, split and play a video. The hardware structure of the video file processing device may be shown in FIG. 1.

FIG. 1 is a schematic diagram illustrating structure of a video file processing device in accordance with various embodiments of the present disclosure. As shown in FIG. 1, hardware of the video file processing device may include: a processor 301, such as CPU, a network interface 304, a user interface 303, a storage 305, and a bus 302. The bus 302 may be responsible for the connection and communication between each component in the video file processing system. The user interface 303 may include: a display, a keyboard, a mouse, etc. and may be used to receive information input by the user and send the received information to the processor 301 for processing. The display may be a Liquid Crystal Display (LCD) screen, a Light-emitting Diode (LED) screen, or a touch screen, which may be used to display data needed to be displayed by the video file processing device, such as display a video file playing operation interface and a video file processing operation interface. The user interface 303 may further include: a standard wired interface or a wireless interface (such as Wireless Fidelity (Wi-Fi) interface). The network interface 304 may include: a standard wired interface or wireless interface (such as Wi-Fi interface). The storage 305 may be a high-speed Random Access Memory (RAM) storage or a non-volatile memory, such as a magnetic disk storage. The storage 305 may be a storage device, which may be independent of the processor 301. As shown in FIG. 1, the storage 305 acting as a computer storage medium may be an Operating System (OS), a network communication module, a user interface or a video file processing program.

In the hardware of the video file processing device shown in FIG. 1, the network interface 304 may be responsible for connecting to an application platform and performing data communication with the application platform. The user interface 303 may be used to connect to the client device, perform data communication with the client device, receive information and instructions input by the client device. The processor 301 may be used to call a video file processing program stored in the storage 305 to execute the following operations:

receiving a splitting instruction of a video file;

obtaining splitting nodes and the video file corresponding to the splitting instruction;

splitting the video file to multiple sub-video files using the splitting nodes; and

storing the multiple sub-video files.

Further, in an embodiment, the processor 301 may call the video file processing program in the storage 305 to execute following operations:

determining video file playing points in time corresponding to the splitting points in time;

splitting the video file to the multiple sub-video files corresponding to the splitting points in time using the determined video file playing points in time.

Further, in an embodiment, the processor 301 may call the video file processing program in the storage 305 to execute following operations:

obtaining splitting duration from the splitting instruction; and

determining the splitting nodes taking the splitting duration as an interval; and

splitting the video file to the multiple sub-video files using the splitting nodes.

Further, in an embodiment, the processor 301 may call the video file processing program in the storage 305 to execute following operations:

obtaining contents and splitting duration of the video file from the splitting instruction; and

determining the splitting nodes according to the contents and splitting duration of the video file.

Further, in an embodiment, the processor 301 may call the video file processing program in the storage 305 to execute following operations:

making a determination as to whether there are sub-video files corresponding to the splitting nodes;

when there are sub-video files corresponding to the splitting nodes, associating the splitting nodes and the sub-video files corresponding to the splitting nodes and storing association relationships between the splitting nodes and the sub-video files corresponding to the splitting nodes;

when there is no sub-video file corresponding to the splitting nodes, splitting the video file to the sub-video files corresponding to the splitting nodes, associating the splitting nodes and the sub-video files corresponding to the splitting nodes and storing the association relationships between the splitting nodes and the sub-video files corresponding to the splitting nodes.

Further, in an embodiment, the processor 301 may call the video file processing program in the storage 305 to execute following operations:

receiving a playing instruction of the video file;

determining a sub-video file corresponding to the playing instruction; and

playing the determined sub-video file.

In embodiments of the present disclosure, with the above technical scheme, the video file may be split to multiple sub-video files via receiving the splitting instruction of the video file, so that the user may select one sub-video file to finish the learning process. The problem of poor video playing efficiency and poor learning efficiency since the existing video file cannot be split according to user's expectations may be avoided. With this scheme, the video file may be split according to the user's expectations, which may improve the video playing efficiency and learning efficiency.

Based on the above hardware structure, embodiments of the video file processing method in embodiments of the present disclosure may be provided.

FIG. 2 is a flow chart illustrating a video file processing method in accordance with various embodiments of the present disclosure. The video file processing method may include following processing.

At block S10, a splitting instruction of a video file may be received.

In an embodiment of the present disclosure, the splitting instruction of the video file may be used to instruct splitting the video file. In this embodiment, the video file processing process may be an application in the teaching field. However, the video file processing process described in embodiments of the present disclosure may not be limited to the application in the teaching field. The video file processing process may be applied to any scenario, which may need to utilize the video file, for instance, the scenario of video on-line playing and video live presentation.

Embodiments of the present disclosure may describe the video file processing process taking the teaching filed for example. In the existing teaching system, an education instruction or an educator may upload an instructional video file to the Internet or storage. The user may watch the instructional video file on the Internet to finish the learning process, or play the recorded instructional video file in the storage to finish the learning process. The user may directly click a link on the Internet to load and watch the instructional video file; or first register with the on-line teaching system to obtain an account and password, and click a corresponding download link to watch or download the instructional video file after finishing the logging operation using the account and password.

A reading instruction of the instructional video file may be received and an instructional video file playing interface may be displayed. After the user needs to split the instructional video file, the splitting instruction of the instructional video file may be sent out, the splitting instruction of the instructional video file may be received and an instructional video file processing interface may be displayed, so that the user may input splitting nodes. The splitting instruction of the instructional video file may be triggered by the user using a physical key, a mouse key or virtual key on the terminal device.

At block S20, splitting nodes corresponding to the splitting instruction may be determined.

After the splitting instruction is received, the splitting nodes and instructional video file corresponding to the splitting instruction may be obtained. That is, the instructional video file, which may need to be split, may be obtained first and the splitting nodes, which may be information indicating how to split the instructional video file. The splitting nodes may include: splitting points in time, which may indicate at which points in time the video file may be split, splitting duration, which may indicate the duration of each video file obtained after the splitting operation, or feature points of the splitting, etc. The user may input the limited splitting duration using the instructional video file processing interface and the instructional video file may be split according to the splitting duration input by the user. For instance, the instructional video file may be split to multiple sub-instructional video files, each of which is 10 minutes. In other embodiments of the present disclosure, the input splitting duration may be that of the compressed instructional video file. The large instructional video file may be compressed and the duration of the compressed instructional video file may be the input splitting duration. For instance, the instructional video file with the duration of 2 hours may be compressed, the duration of the compressed instructional video file may be 30 minutes, and only important parts of the instructional video file may be retained. In an alternative, the instructional video file with the duration of 1 hour may be compressed and the duration of the compressed instructional video file is 20 minutes. The durations of the instructional video file may be selected according to the users' requirements.

At block S30, the video file may be split to multiple sub-video files according to the splitting nodes and the sub-video files obtained after the splitting operation may be stored.

After the splitting nodes and the instructional video file corresponding the splitting instruction are obtained, the instructional video file may be split to the sub-instructional video files corresponding to the splitting nodes and the sub-instructional video files after the splitting operation may be stored, so that the user may select a corresponding sub-instructional video file to finish the learning.

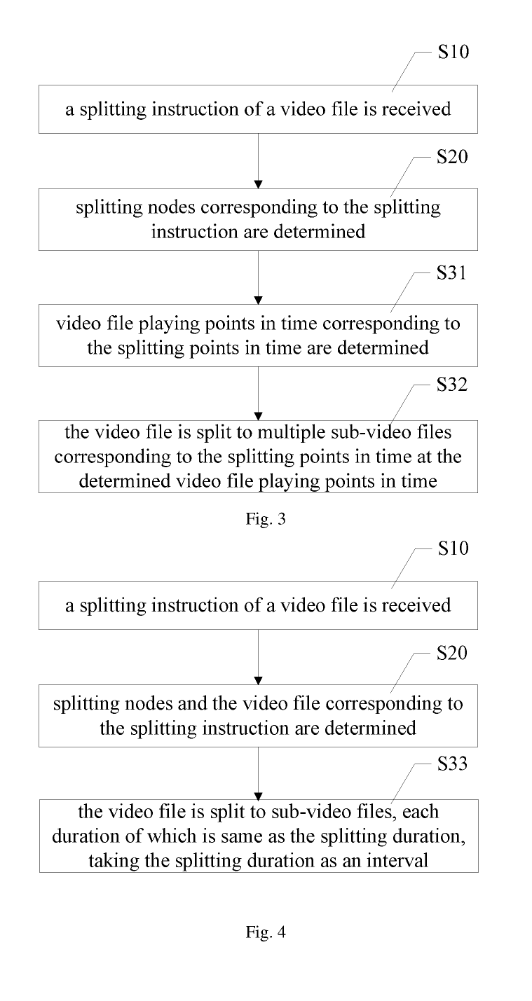

FIG. 3 is a flow chart illustrating a video file splitting method in accordance with various embodiments of the present disclosure. Specifically, when the splitting nodes are splitting points in time, referring to FIG. 3, the process for splitting the instructional video file to the sub-instructional video files corresponding to the splitting nodes may include following blocks.

At block S31, video file playing points in time corresponding to the splitting points in time may be determined.

The splitting points in time may be those input by the user in the instructional video file processing interface. The splitting points in time may be the 15th minute, 40th minute or 50th minute, etc. The splitting points in time input by the user may be received, instructional video file playing points in time of the instructional video file corresponding to the splitting points in time may be determined. That is, the positions of the splitting points in time in the instructional video may be determined.

At block S32, the video file may be split to multiple sub-video files corresponding to the splitting points in time at the determined video file playing points in time.

After the instructional video file playing points in time of the instructional video file corresponding to the splitting points in time, the instructional video file may be split to the sub-instructional video files corresponding to the splitting points in time at the determined instructional video file playing points in time. For instance, the splitting points in time may be the 15th minute, 30th minute or 45th minute, etc. The total duration of the instructional video file may be 100 minutes. The instructional video file may be split to four sub-instructional video files, which may respectively range from the 0th minute to 15th minute, from 15th minute to 30th minute, from 30th minute to 45th minute and from 45th minute to 100th minute. Identification names used for identifying the four sub-instructional video files may be set for the four sub-instructional video files. For instance, sub-instructional video file ranging from the 0th minute to the 15th minute may be set as 15 minutes, the sub-instructional video file ranging from 15th minute to 30th minute may be set as 15-30 minutes, the sub-instructional video file ranging from 30th to 45th minute may be set as 30-45 minutes, and the sub-instructional video file ranging from 45th to 100th may be set as 45-100 minutes. When the instructional video file is A, the sub-instructional video file ranging from 0th to 15th may be set as A1 minutes, the sub-instructional video file ranging from 15th to 30th may be set as A2 minutes, the sub-instructional video file ranging from 30th to 45th may be set as A3 minutes, and the sub-instructional video file ranging from 45th to 100th may be set as A4 minutes. Other setting modes for the user to distinguish the each sub-instructional video file may also be adopted.

After splitting the instructional video file to multiple sub-instructional video files, the sub-instructional video files may be associated. An association operation may include: associating the sub-instructional video files belonging to the same instructional video file and associating the sub-instructional video files belonging to the same instructional video file with the user corresponding to the splitting instruction, so that after different users log into the instructional system, all of the users may browse and watch the sub-instructional video files set for each of them. Therefore, the reading and watching of the instructional video files may be more individualized and diversified and watching efficiency and experience of the instructional video file may be improved.

FIG. 4 is a flow chart illustrating a video file splitting method in accordance with various embodiments of the present disclosure. Specifically, when the splitting nodes are splitting points in time, referring to FIG. 4, the process for splitting the instructional video file to the sub-instructional video files corresponding to the splitting nodes may include following blocks.

At block S33, the video file may be split to sub-video files, each duration of which may be same as the splitting duration, taking the splitting duration as an interval.

When the splitting duration is received, for instance, the splitting duration may be 15 minutes or 30 minutes, the splitting duration may be input by the user. The instructional video file may be split to multiple sub-instructional video files taking the splitting duration as the interval. For instance, the duration of the instructional video file may be 120 minutes and the splitting duration may be 30 minutes, the instructional video file may be divided to four sub-instructional video files, which may respectively range from 0th minute to 30th minute, from 30th minute to 60th minute, from 60th minute to 90th minute and from 90th minute to 120th minute. When the instructional video file cannot be equally split to multiple sub-instructional video files according to the splitting duration, after the last complete sub-instructional video file, duration of which may be the same as the splitting duration, remain un-split instructional video file may be taken as a sub-instructional video file. For instance, the duration of the instructional video file may be 100 minutes and the splitting duration may be 30 minutes, the part of the instructional video file ranging from 90th minute to 100th minute may be taken as a sub-instructional video file. In other embodiments of the present disclosure, the user may input feature points of at least one instructional video file in the instructional video file processing operating interface and the instructional video file may be split to multiple sub-instructional video files according to the input feature points. For instance, the splitting nodes may be determined according to contents of the video file and the splitting duration and the video file may be split according to the splitting nodes.

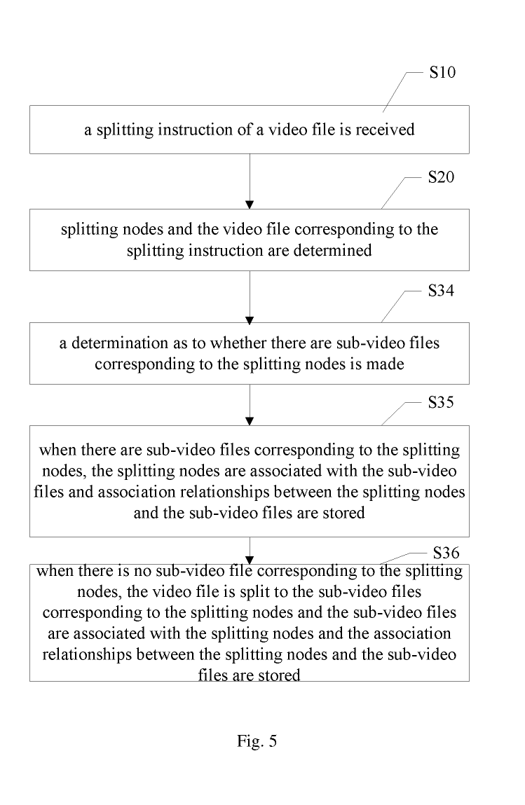

FIG. 5 is a flow chart illustrating a video file splitting method in accordance with various embodiments of the present disclosure. In other embodiments of the present disclosure, referring to FIG. 5, the process for splitting the instructional video file to the corresponding sub-instructional video files corresponding to the splitting nodes may include following blocks.

At block S34, a determination as to whether there may be sub-video files corresponding to the splitting nodes may be made.

At block S35, when there are sub-video files corresponding to the splitting nodes, the splitting nodes may be associated with the sub-video files and association relationships between the splitting nodes and the sub-video files may be stored.

At block S36, when there is no sub-video file corresponding to the splitting nodes, the video file may be split to the sub-video files corresponding to the splitting nodes and the sub-video files may be associated with the splitting nodes and the association relationships between the splitting nodes and the sub-video files may be stored.

After the splitting nodes and the instructional video file are obtained, a determination as to whether there may be sub-instructional video files corresponding to the splitting nodes may be made. When there are sub-instructional video files corresponding to the splitting nodes, the sub-instructional video files may be associated with the splitting nodes and the association relationships between the sub-instructional video files and the splitting nodes may be stored. When there are sub-instructional video files corresponding to partial of the splitting nodes, the un-split instructional video file may be split to obtain un-stored sub-instructional video files, i.e., those which may correspond to the splitting nodes except for those corresponding to the stored sub-instructional video files. The stored sub-instructional video files and the partial splitting nodes used to split the instructional video file to obtain the stored sub-instructional video files may be associated and stored. The association and storing processing here may be the same as that mentioned above, which may not be repeated here. When there is no sub-instructional video file corresponding to the splitting nodes, the instructional video file may be split to the sub-instructional video files corresponding to the splitting nodes and the sub-instructional video files obtained by the splitting operation may be stored.

The video file processing device may split a video file to multiple video sub-files based on a splitting instruction of the video file, so that the user may select a sub-instructional video file to finish the learning process. The problem of poor video playing efficiency and poor learning efficiency since the existing video file cannot be split according to user's expectations may be avoided. With this scheme, the video file may be split according to the user's expectations, which may improve the video playing efficiency and learning efficiency.

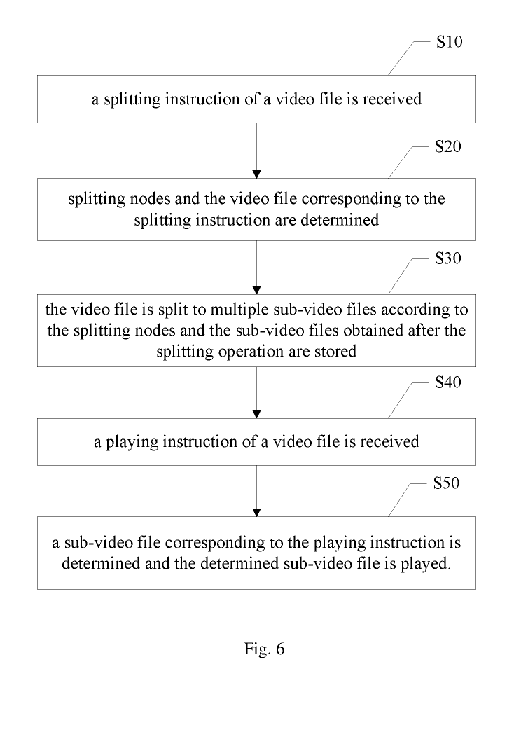

Further, based on the above first embodiment of the instructional video file processing method, a second embodiment of the present disclosure may be provided. FIG. 6 is a flow chart illustrating a video file processing method in according with various embodiments of the present disclosure. As shown in FIG. 6, after block S30, the method may further include following blocks.

At block S40, a playing instruction of a video file may be received.

At block S50, a sub-video file corresponding to the playing instruction may be determined and the determined sub-video file may be played.

After successfully splitting the instructional video file to the multiple sub-instructional video files, a playing instruction of the instructional video file may be received. After the playing instruction of the instructional video file, a sub-instructional video file corresponding to the playing instruction may be determined and the sub-instructional video file may be played. Or, the sub-instructional video file associated with the playing instruction may be directly played. After successfully playing the sub-instructional video file, the user may be prompted for the successful playing of the sub-instructional video file. In other embodiments of the present disclosure, in order to further improve the efficiency and planning of the teaching, the splitting instruction of the sub-instructional video file may be further received. The sub-instructional video file may be further split to multiple sub-instructional video files. Therefore, the user may select the sub-instructional video file that may fit the user's schedule to learn and the learning efficiency may be improved.

In embodiments of the present disclosure, by reading the sub-instructional video files obtained after the splitting operation, the learning processing may match the user's expectation, which may improve the teaching efficiency.

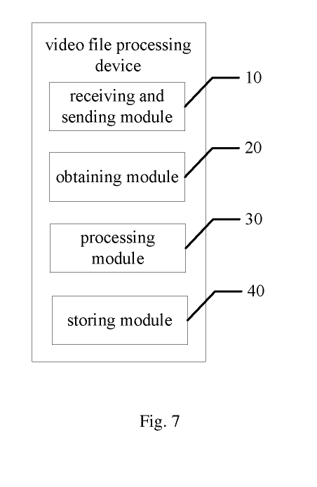

Accordingly, a first embodiment of video file processing device may be provided. FIG. 7 is a schematic diagram illustrating structure of a video file processing device in accordance with various embodiments of the present disclosure. Referring to FIG. 7, the video file processing device may include: a receiving and sending module 10, an obtaining module 20, a processing module 30 and a storing module 40.

The receiving and sending module 10 may be to receive a splitting instruction of a video file.

In the existing teaching system, an education instruction or an educator may upload an instructional video file to the Internet or storage. The user may watch the instructional video file on the Internet to finish the learning process, or play the recorded instructional video file in the storage to finish the learning process. The user may directly click a link on the Internet to load and watch the instructional video file; or first register with the on-line teaching system to obtain an account and password, and click a corresponding download link to watch or download the instructional video file after finishing the logging operation using the account and password.

A reading instruction of the instructional video file may be received and an instructional video file playing interface may be displayed. After the user needs to split the instructional video file, the splitting instruction of the instructional video file may be sent out, the splitting instruction of the instructional video file may be received and an instructional video file processing interface may be displayed, so that the user may input splitting nodes. The splitting instruction of the instructional video file may be triggered by the user using a physical key, a mouse key or virtual key on the terminal device.

The obtaining module 20 may be to determine splitting nodes corresponding to the splitting instruction.

After the splitting instruction is received, the splitting nodes and instructional video file corresponding to the splitting instruction may be obtained. That is, the instructional video file, which may need to be split, may be obtained first and the splitting nodes, which may indicate how to split the instructional video file. The splitting nodes may include: splitting points in time, which may indicate at which points in time the video file may be split, splitting duration, which may indicate the duration of each video file obtained after the splitting operation, or feature points of the splitting, etc. The user may input the limited splitting duration using the instructional video file processing interface and the instructional video file may be split according to the splitting duration input by the user. For instance, the instructional video file may be split to multiple sub-instructional video files, each of which is 10 minutes. In other embodiments of the present disclosure, the input splitting duration may be that of the compressed instructional video file. The large instructional video file may be compressed and the duration of the compressed instructional video file may be the input splitting duration. For instance, the instructional video file with the duration of 2 hours may be compressed, the duration of the compressed instructional video file may be 30 minutes, and only important parts of the instructional video file may be retained. In an alternative, the instructional video file with the duration of 1 hour may be compressed and the duration of the compressed instructional video file is 20 minutes. The durations of the instructional video file may be selected according to the users' requirements.

The processing module 30 may be to split the video file to multiple sub-video files using the splitting nodes.

The storing module 40 may be to store the multiple sub-video files.

After obtaining the splitting nodes and the instructional video file corresponding to the splitting instruction, the instructional video file may be split to sub-instructional video files corresponding to the splitting nodes, and the sub-instructional video files obtained by the splitting operation may be stored. Therefore, the video file may be segmentally managed, which may optimize the management of the video file. Further, the user may select one of the sub-instructional video files to finish the learning process.

In an embodiment of the present disclosure, the obtaining module 20 may be further to obtain splitting points in time from the splitting instruction and determine video file playing points in time corresponding to the splitting points in time. The processing module 30 may be further to split the video file to the multiple sub-video files using the video file playing points in time.

The splitting points in time may be those input by the user in the instructional video file processing interface. The splitting points in time may be the 15th minute, 40th minute or 50th minute, etc. The splitting points in time input by the user may be received, instructional video file playing points in time of the instructional video file corresponding to the splitting points in time may be determined. That is, the positions of the splitting points in time in the instructional video may be determined.

After the instructional video file playing points in time of the instructional video file corresponding to the splitting points in time, the instructional video file may be split to the sub-instructional video files corresponding to the splitting points in time at the determined instructional video file playing points in time. For instance, the splitting points in time may be the 15th minute, 30th minute or 45th minute, etc. The total duration of the instructional video file may be 100 minutes. The instructional video file may be split to four sub-instructional video files, which may respectively range from the 0th minute to 15th minute, from 15th minute to 30th minute, from 30th minute to 45th minute and from 45th minute to 100th minute. Identification names used for identifying the four sub-instructional video files may be set for the four sub-instructional video files. For instance, sub-instructional video file ranging from the 0th minute to the 15th minute may be set as 15 minutes, the sub-instructional video file ranging from 15th minute to 30th minute may be set as 15-30 minutes, the sub-instructional video file ranging from 30th to 45th minute may be set as 30-45 minutes, and the sub-instructional video file ranging from 45th to 100th may be set as 45-100 minutes. When the instructional video file is A, the sub-instructional video file ranging from 0th to 15th may be set as A1 minutes, the sub-instructional video file ranging from 15th to 30th may be set as A2 minutes, the sub-instructional video file ranging from 30th to 45th may be set as A3 minutes, and the sub-instructional video file ranging from 45th to 100th may be set as A4 minutes. Other setting modes for the user to distinguish the each sub-instructional video file may also be adopted.

After splitting the instructional video file to multiple sub-instructional video files, the sub-instructional video files may be associated. An association operation may include: associating the sub-instructional video files belonging to the same instructional video file and associating the sub-instructional video files belonging to the same instructional video file with the user corresponding to the splitting instruction, so that after different users log into the instructional system, all of the users may browse and watch the sub-instructional video files set for each of them. Therefore, the reading and watching of the instructional video files may be more individualized and diversified and watching efficiency and experience of the instructional video file may be improved.

In an embodiment of the present disclosure, the obtaining module 20 may be further to obtain splitting duration of the video file from the splitting instruction; and determine the splitting nodes taking the splitting duration as the interval.

When the splitting duration is received, for instance, the splitting duration may be 15 minutes or 30 minutes, the splitting duration may be input by the user. The instructional video file may be split to multiple sub-instructional video files taking the splitting duration as the interval. For instance, the duration of the instructional video file may be 120 minutes and the splitting duration may be 30 minutes, the instructional video file may be divided to four sub-instructional video files, which may respectively range from 0th minute to 30th minute, from 30th minute to 60th minute, from 60th minute to 90th minute and from 90th minute to 120th minute. When the instructional video file cannot be equally split to multiple sub-instructional video files according to the splitting duration, after the last complete sub-instructional video file, duration of which may be the same as the splitting duration, remain un-split instructional video file may be taken as a sub-instructional video file. For instance, the duration of the instructional video file may be 100 minutes and the splitting duration may be 30 minutes, the part of the instructional video file ranging from 90th minute to 100th minute may be taken as a sub-instructional video file. In other embodiments of the present disclosure, the user may input feature points of at least one instructional video file in the instructional video file processing operating interface and the instructional video file may be split to multiple sub-instructional video files according to the input feature points. For instance, the splitting nodes may be determined according to contents of the video file and the splitting duration and the video file may be split according to the splitting nodes.

In an embodiment of the present disclosure, the obtaining module 20 may be further to obtain contents and splitting duration of the video file from the splitting instruction; and determine the splitting nodes according to the contents and splitting duration of the video file.

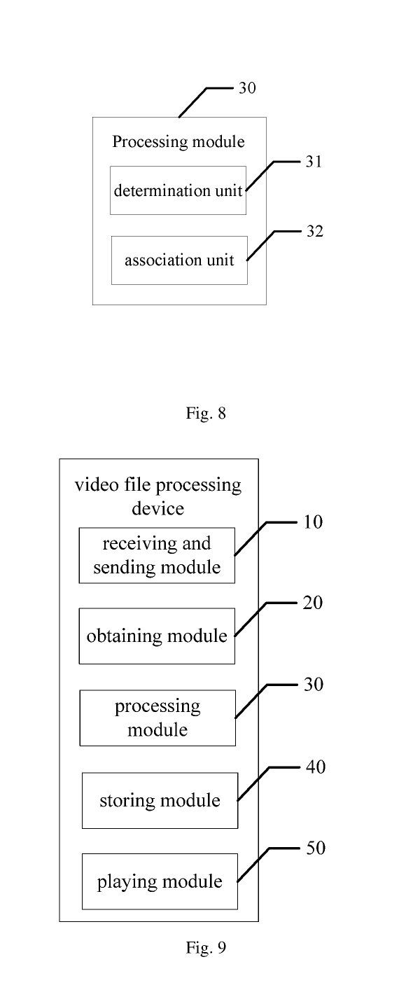

FIG. 8 is a schematic diagram illustrating the structure of the processing module in FIG. 7. Referring to FIG. 8, the processing module 30 may include: a determination unit 31 and an association unit 32.

The determination unit 31 may be to make a determination as to whether there are sub-video files corresponding to the splitting nodes.

The association unit 32 may be to when there are sub-video files corresponding to the splitting nodes, associate the splitting nodes and the sub-video files corresponding to the splitting nodes and store association relationships between the splitting nodes and the sub-video files corresponding to the splitting nodes.

The processing module 30 may be to when there is no sub-video file corresponding to the splitting nodes, split the video file to the sub-video files corresponding to the splitting nodes, associate the splitting nodes and the sub-video files corresponding to the splitting nodes and store the association relationships between the splitting nodes and the sub-video files corresponding to the splitting nodes.

After the splitting nodes and the instructional video file are obtained, a determination as to whether there may be sub-instructional video files corresponding to the splitting nodes may be made. When there are sub-instructional video files corresponding to the splitting nodes, the sub-instructional video files may be associated with the splitting nodes and the association relationships between the sub-instructional video files and the splitting nodes may be stored. When there are sub-instructional video files corresponding to partial of the splitting nodes, the un-split instructional video file may be split to obtain un-stored sub-instructional video files, i.e., those which may correspond to the splitting nodes except for those corresponding to the stored sub-instructional video files. The stored sub-instructional video files and the partial splitting nodes used to split the instructional video file to obtain the stored sub-instructional video files may be associated and stored. The association and storing processing here may be the same as that mentioned above, which may not be repeated here. When there is no sub-instructional video file corresponding to the splitting nodes, the instructional video file may be split to the sub-instructional video files corresponding to the splitting nodes and the sub-instructional video files obtained by the splitting operation may be stored.

In embodiments of the present disclosure, an instructional video file may be split to multiple video sub-files based on a splitting instruction of the video file, so that the user may select a sub-instructional video file to finish the learning process. The problem of poor video playing efficiency and poor learning efficiency since the existing video file cannot be split according to user's expectations may be avoided. With this scheme, the video file may be split according to the user's expectations, which may improve the video playing efficiency and learning efficiency.

Further, based on the above first embodiment of the video file processing device, a second embodiment of the video file processing device may be provided. FIG. 9 is a schematic diagram illustrating structure of a video file processing device in accordance with various embodiments of the present disclosure. Referring to FIG. 9, the video file processing device may further include: a playing module 50.

The receiving and sending module 10 may be further to receive a playing instruction of the video file.

The obtaining module 20 may be further to determine a sub-video file corresponding to the playing instruction.

The playing module 50 may be further to play the determined sub-video file.

After successfully splitting the instructional video file to the multiple sub-instructional video files, a playing instruction of the instructional video file may be received. After the playing instruction of the instructional video file is received, a sub-instructional video file corresponding to the playing instruction may be determined and the sub-instructional video file may be played. Or, the sub-instructional video file associated with the playing instruction may be directly played. After successfully playing the sub-instructional video file, the user may be prompted for the successful playing of the sub-instructional video file. In other embodiments of the present disclosure, in order to further improve the efficiency and planning of the teaching, the splitting instruction of the sub-instructional video file may be further received. The sub-instructional video file may be further split to multiple sub-instructional video files. Therefore, the user may select the sub-instructional video file that may fit the user's schedule to learn and the learning efficiency may be improved.

In embodiments of the present disclosure, after reading the sub-instructional video file obtained after the splitting operation, the learning process may match the user's expectation and the teaching efficiency may be improved.

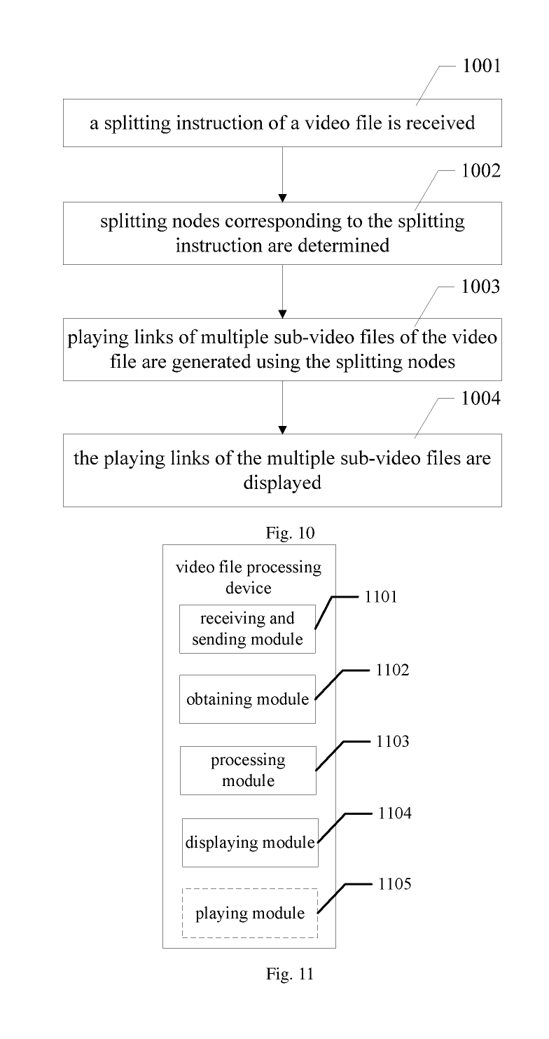

As shown in FIG. 10, FIG. 10 is a flow chart illustrating a video file processing method in accordance with various embodiments of the present disclosure. FIG. 10 may include following blocks.

At block 1001, a splitting instruction of a video file may be received.

At block 1002, splitting nodes corresponding to the splitting instruction may be determined.

At block 1003, playing links of multiple sub-video files of the video file may be generated using the splitting nodes.

At block 1004, the playing links of the multiple sub-video files may be displayed.

In an embodiment of the present disclosure, generating the playing links of the multiple sub-video files of the video file using the splitting nodes may include: splitting playing duration of the video file to multiple sub-playing periods using the splitting nodes; and generating a playing link of a sub-video file for each playing period.

In an embodiment of the present disclosure, the method may further include: receive a playing instruction of a sub-video file; hide in a player, contents of sub-video files except for the sub-video file corresponding to the playing instruction in the video file; update a progress bar of the player as a progress bar of a playing period corresponding to the sub-video file corresponding to the playing instruction; and play the sub-video file corresponding to the playing instruction in the player according to the progress bar of the playing period.

In this embodiment of the present disclosure, a splitting instruction of a video file may be received, splitting nodes corresponding to the splitting instruction may be determined, the playing links of the multiple sub-video files of the video file may be generated using the splitting nodes, and the playing links of the multiple sub-video files may be generated. In the embodiments of the present disclosure, after the splitting nodes are determined, the video file may not be split to the multiple sub-video files using the splitting nodes. Instead, multiple playing links may be generated and each playing link may correspond to one playing period. With the technical scheme provided by this embodiment of the present disclosure, the video file may be virtually split. What are displayed are the playing links of the multiple sub-video files. The video file may not been split to multiple sub-video files, and the duration of the video file may have been split to multiple playing periods. Contents corresponding to each playing period may be virtualized to a sub-video file. When a video file of a playing period is played, i.e., a sub-video file is played, contents of other playing periods may be hid and the process bar of the player may be updated as that fitting for the playing period. From the point of view of the user, contents of a sub-video file may be played. Actually, what have been played may be the contents of a certain playing period of the video file. With this embodiment, the video file may not need to be split to multiple sub-video files, which may save the system resources and system time used by the splitting operation. Further, the damage of video file resulting from the splitting operation may be avoided.

FIG. 11 is a schematic diagram illustrating a video file processing device in accordance with various embodiments of the present disclosure. As shown in FIG. 11, the device may include: a receiving and sending module 1101, an obtaining module 1102, a processing module 1103 and a displaying module 1104.

The receiving and sending module 1101 may be to receive a splitting instruction of a video file;

the obtaining module 1102 may be to determine splitting nodes corresponding to the splitting instruction;

the processing module 1103 may be to generate playing links of multiple sub-video files of the video file using the splitting nodes; and

the displaying module 1104 may be to display the playing links of the multiple sub-video files.

In an embodiment of the present disclosure, the processing module 1103 may be further to split playing duration of the video file to multiple sub-playing periods using the splitting nodes, and generate a playing link of a sub-video file for each playing period.

In an embodiment of the present disclosure, the device may further include a playing module 1105.

The receiving and sending module 1101 may be further to receive a playing instruction of a sub-video file; and

the playing module 1105 may be to hide, in a player, contents of sub-video files except for the sub-video file corresponding to the playing instruction in the video file, update a progress bar of the player as a progress bar of a playing period corresponding to the sub-video file corresponding to the play instruction, and play the sub-video file corresponding to the playing instruction in the player according to the progress bar of the playing period.

In an embodiment of the present disclosure, the above processor 301 may be further used to call the video file processing program stored in the storage 305 to execute the above method in FIG. 10 and the device in FIG. 11.

It should be noted that in the present disclosure, the term “include” and “comprise” or any other variation may be non-exclusive. So, processes, methods, products or devices including a serial of elements may not only include those elements, but also include other elements which may not have been listed, or may include inherent elements of the processes, methods, products or devices. Without more limitations, the element defined by the sentence “including one . . . ” may not exclude that there may be other same elements in the process, method, product or device including the element.

The above embodiments of the present disclosure only may be used to describe the present disclosure, but may not be used to limit the present disclosure.

With the above description of the embodiments, a person skilled in the art of the present disclosure may clearly know that the above method embodiments may be implemented using software and general hardware platform. Certainly, the above method embodiments may be implemented via hardware. Based on this understanding, the technical scheme of the present disclosure or those parts of the present disclosure contributing to the prior art may be embodied by software product. The computer software product may be stored in a storage (such as a Read Only Memory (ROM)/Random Access Memory (RAM), disk, Compact Disc (CD)) and may include several instructions, with which a terminal device (may be the smart phone, computer, server or network device, etc.) may execute the methods in each embodiment of the present disclosure.

What is claimed is:

1. A video file processing method, which is implemented by a computer comprising a processor and a storage, wherein the processor executes instructions in the storage to execute following operations:
receiving a splitting instruction of a video file;
determining splitting nodes corresponding to the splitting instruction;
splitting the video file to multiple sub-video files using the splitting nodes; and
storing the multiple sub-video files.

2. The method according to claim 1, wherein determining the splitting nodes corresponding to the splitting instruction comprises: obtaining splitting points in time from the splitting instruction and determining video file playing points in time corresponding to the splitting points in time;
splitting the video file to the multiple sub-video files using the splitting nodes comprises: splitting the video file to the multiple sub-video files using the video file playing points in time.

3. The method according to claim 1, wherein determining the splitting nodes corresponding to the splitting instruction comprises:
obtaining splitting duration from the splitting instruction; and
determining the splitting nodes taking the splitting duration as an interval.

4. The method according to claim 1, wherein determining the splitting nodes corresponding to the splitting instruction comprises:
obtaining contents and splitting duration of the video file from the splitting instruction; and
determining the splitting nodes according to the contents and splitting duration of the video file.

5. The method according to claim 1, wherein splitting the video file to the multiple sub-video files using the splitting nodes comprises:
making a determination as to whether there are sub-video files corresponding to the splitting nodes;
when there are sub-video files corresponding to the splitting nodes, associating the splitting nodes and the sub-video files corresponding to the splitting nodes and storing association relationships between the splitting nodes and the sub-video files corresponding to the splitting nodes;
when there is no sub-video file corresponding to the splitting nodes, splitting the video file to the sub-video files corresponding to the splitting nodes, associating the splitting nodes and the sub-video files corresponding to the splitting nodes and storing the association relationships between the splitting nodes and the sub-video files corresponding to the splitting nodes.

6. The method according to claim 1, further comprising:
receiving a playing instruction of the video file;
determining a sub-video file corresponding to the playing instruction; and
playing the determined sub-video file.

7. A video file processing device, comprising: a processor and a storage;
wherein the processor executes a video file processing program in the storage to:
receive a splitting instruction of a video file;
determine splitting nodes corresponding to the splitting instruction;
split the video file to multiple sub-video files using the splitting nodes; and
store the multiple sub-video files.

8. The device according to claim 7, wherein the processor further executes the video file processing program in the storage to:
obtain splitting points in time from the splitting instruction and determine video file playing points in time corresponding to the splitting points in time;
split the video file to the multiple sub-video files using the video file playing points in time.

9. The device according to claim 7, wherein the processor further executes the video file processing program in the storage to:
obtain splitting duration from the splitting instruction and determine the splitting nodes taking the splitting duration as an interval.

10. The device according to claim 7, wherein the processor further executes the video file processing program in the storage to:
obtain contents and splitting duration of the video file from the splitting instruction and determine the splitting nodes according to the contents and splitting duration of the video file.

11. The device according to claim 7, wherein the processor further executes the video file processing program in the storage to:
make a determination as to whether there are sub-video files corresponding to the splitting nodes;
when there are sub-video files corresponding to the splitting nodes, associate the splitting nodes and the sub-video files corresponding to the splitting nodes and store association relationships between the splitting nodes and the sub-video files corresponding to the splitting nodes;
when there is no sub-video file corresponding to the splitting nodes, split the video file to the sub-video files corresponding to the splitting nodes, associate the splitting nodes and the sub-video files corresponding to the splitting nodes and store the association relationships between the splitting nodes and the sub-video files corresponding to the splitting nodes.

12. The device according to claim 7, the processor further executes the video file processing program in the storage to:
receive a playing instruction of the video file;
determine a sub-video file corresponding to the playing instruction; and
play the determined sub-video file.

13. A video file processing method, which is implemented by a computer comprising a processor and a storage, wherein the processor executes instructions in the storage to execute following operations:
receiving a splitting instruction of a video file;
determining splitting nodes corresponding to the splitting instruction;
generating playing links of multiple sub-video files of the video file using the splitting nodes; and
displaying the playing links of the multiple sub-video files.

14. The method according to claim 13, wherein generating the playing links of the multiple sub-video files of the video file using the splitting nodes comprises:
splitting playing duration of the video file to multiple sub-playing periods using the splitting nodes;
generating a playing link of a sub-video file for each playing period.

15. The method according to claim 14, further comprising:
receiving a playing instruction of a sub-video file;
hiding, in a player, contents of sub-video files except for the sub-video file corresponding to the playing instruction in the video file;
updating a progress bar of the player as a progress bar of a playing period corresponding to the sub-video file corresponding to the playing instruction; and
playing the sub-video file corresponding to the playing instruction in the player according to the progress bar of the playing period.

16. A video file processing device, comprising: a processor and a storage;
wherein the processor executes a video file processing program in the storage to:
receive a splitting instruction of a video file;
determine splitting nodes corresponding to the splitting instruction;
generate playing links of multiple sub-video files of the video file using the splitting nodes; and
display the playing links of the multiple sub-video files.

17. The device according to claim 16, wherein the processor further executes the video file processing program in the storage to:
split playing duration of the video file to multiple sub-playing periods using the splitting nodes, and generate a playing link of a sub-video file for each playing period.

18. The device according to claim 17, the processor further executes the video file processing program in the storage to:
receive a playing instruction of a sub-video file; and
hide, in a player, contents of sub-video files except for the sub-video file corresponding to the playing instruction in the video file, update a progress bar of the player as a progress bar of a playing period corresponding to the sub-video file corresponding to the play instruction, and play the sub-video file corresponding to the playing instruction in the player according to the progress bar of the playing period.
